(19) United States
(12) Patent Application Publication
(10) Pub. No.: US 2003/0049468 A1
(43) Pub. Date: Mar. 13, 2003

(54) Cascade arc plasma and abrasion resistant coatings made therefrom

(76) Inventors: Ing-Feng Hu, Midland, MI (US); Xiao-Ming He, Arcadia, CA (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/219,151

(22) Filed: Aug. 15, 2002

Related U.S. Application Data
(60) Provisional application No. 60/312,769, filed on Aug. 16, 2001.

(51) Int. Cl. H05F 3/00; B01J 19/08; B01J 19/12; B32B 13/12

(52) U.S. Cl. 428/451; 422/186.04; 204/164

(57) ABSTRACT

The present invention relates a cascade arc plasma apparatus that produces plasma easily and without contamination through the incorporation of a DC pulsed power source. A variety of substrates and configurations can be coated quickly and efficiently without the need for a tie layer to produce scratch and abrasion resistant materials and materials that improved impermeability to gases.

### CROSS-REFERENCE TO RELATED APPLICATION

This application claims the benefit of U.S. Provisional Application No. 60/312,769, filed on Aug. 16, 2001.

### BACKGROUND OF THE INVENTION

This invention relates to a cascade arc plasma device and abrasion resistant coatings made therefrom.

In conventional cascade arc plasma technology (described, for example, by Wallsten et al. in U.S. Pat. No. 4,948,485) plasma is created in a cascade arc generator to form a plasma torch. A monomeric gas such as a hydrocarbon, a halogenated hydrocarbon, a silane, or an organosilane is then injected into the plasma torch, optionally in the presence of oxygen, and at a pressure on the order of about 10 Torr or less, and the resultant stream is deposited onto a substrate to form a plasma polymerized film.

One of the drawbacks of cascade arc plasma technology is the difficulty in producing the plasma in the first place. A second and perhaps related problem is contamination by tungsten and copper at the cascade arc plasma source, necessitating the use of a shutter between the source and the substrate to prevent unwanted deposition.

It would therefore be advantageous to develop a cascade arc plasma device that produces plasma easily and without contamination. It would be a further advantageous if such a device produced more uniform plasma coverage over a larger area of the substrate, and could be controlled at a lower temperature so that substrates such as polycarbonate can be plasma coated without degradation.

### SUMMARY OF THE INVENTION

In a first aspect, the present invention addresses the deficiencies in the art of cascade arc plasma by providing a cascade arc plasma apparatus comprising 1) a cascade arc source having a plurality of aligned concentric metallic discs separated by insulator rings, wherein the discs and rings contain a central aperture defining a conduit having an inlet and and an outlet for a carrier gas, which metallic discs float electrically between a cathode proximate to the inlet of the conduit and an anode proximate to the outlet of the conduit; 2) a DC pulsed voltage power source connected to the cathode and the anode; 3) a carrier gas source in communication with the inlet of the cascade arc source; 4) a vacuum deposition chamber in communication with the outlet of the cascade arc source, wherein the vacuum deposition chamber has a means for evacuation and at least one inlet for the introduction of monomer gas and optionally oxygen; 5) a source for a reactant in communication with the inlet of the vacuum deposition chamber; and 6) a substrate within the vacuum deposition chamber to receive plasma polymerized material.

In a second aspect, the present invention is a method for coating a substrate using cascade arc plasma comprising the steps of 1) applying a DC pulse to generate a plasma in a cascade arc source having a plurality of aligned concentric metallic discs separated by insulator rings, wherein the discs and rings contain a central aperture defining a conduit having an inlet and an outlet for a carrier gas, wherein the metallic rings float electrically between a cathode proximate to the inlet of the conduit and an anode proximate to an outlet of the conduit, wherein the DC pulse is connected to the cathode and the anode; 2) concomitantly flowing a carrier gas through the conduit to form a cascade arc jet in a vacuum deposition chamber in communication with the outlet side of the cascade arc source; 3) contacting the cascade arc jet with a reactant and optionally an ancillary reactive gas to form a plasma polymerized material; and 4) depositing the plasma polymerized material onto a substrate within the vacuum deposition chamber.

In a third aspect, the present invention is a composition comprising a polyolefinic substrate coated with a polyorganic silicon layer in the absence of tie layer for the substrate and the polyorganosilicon layer, wherein the coated substrate has a cross-hatch peel-off strength of 4 or 5.

### BRIEF DESCRIPTION OF DRAWINGS

FIG. 1 is an illustration of a DC-pulsed cascade arc plasma deposition apparatus.

FIG. 2. is a top view depicting a metallic disc with a channel for coolant.

### DETAILED DESCRIPTION OF THE INVENTION

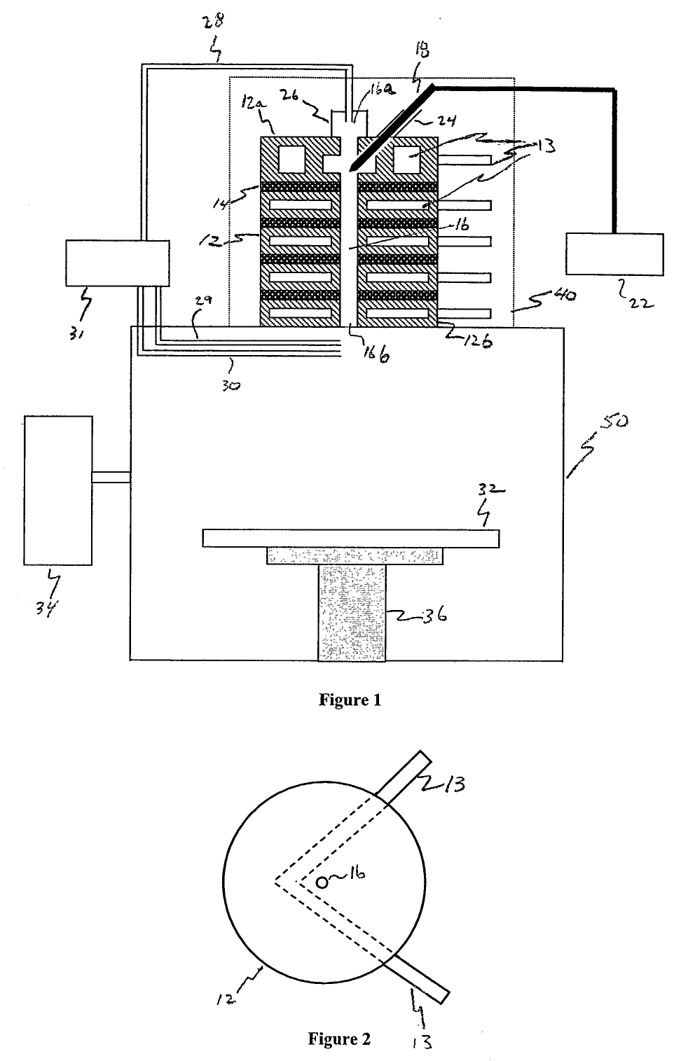

FIG. 1 illustrates a preferred embodiment of the apparatus of the present invention. The apparatus (10) includes a cascade arc source (40) in communication with a chamber (50). The Cascade Arc Source The cascade arc source (40) comprises a plurality of aligned concentric metallic discs (12), preferably copper discs, separated by insulator spacers (14). Each of the discs (12) and spacers (14) contain a central aperture which defines a conduit (16) having an inlet (16a) and an outlet (16b) for a carrier gas, which is a gas does not react with either copper or tungsten at high temperatures. The spacers (14) may be made of any suitable insulating material such as rubber or ceramic or a combination thereof. The carrier gas is flowed through a carrier gas channel (28) and preferably controlled by a mass flow controller (31). Preferred carrier gases include argon, helium, and xenon, with argon being more preferred. The carrier gas flow rates are sufficiently high to generate a supersonic flow in the conduit (16). Preferably, the carrier gas flow rate is not less than 500 standard cm³/min (sccm), more preferably not less than 1000 seem, and most preferably not less than 1500 sccm, and preferably not more than 5000 sccm, more preferably not more than 3000 sccm, and most preferably not more than 2000 sccm.

The discs (12) float electrically between a cathode (18) at the inlet of the conduit (16a) and an anode (12b) situated at the outlet of the conduit. The discs (12) additionally contain cooling channels (13) so that coolant can be flowed through the core of the discs (12) to control the temperature of the generated arc.

The cathode (18) is preferably a tungsten filament and preferably sealed (for example, vacuum cemented) in a ceramic tube (24) and is preferably situated so that the tip of filament (18) is centrally disposed just above or at the inlet (16a). The anode (12b) is grounded and is preferably made of the same material as the discs (12). Moreover, the anode (12b) is generally in contact with the disc furthest away from the disc that is in contact with the cathode (18). The discs (12) preferably have a diameter of not less than 10 mm, more preferably not less than 50 mm and preferably not greater 200 mm, more preferably not greater than 100 mm. The uppermost disc is the cathode assembly plate (12a), which is in contact with the filament (18). This cathode assembly plate (12a) has a thickness which is typically greater than the thickness of the other discs (12) so as to accommodate the filament (18) and a carrier gas connection junction (26) connected to the carrier gas inlet (16a).

The diameter of the conduit (16) is sufficiently wide to accommodate the filament (18) and sufficiently narrow to constrict the gas flow and is preferably from about 1 to 6 mm has a length of preferably not less than 20, more preferably not less than 40, and preferably not more than 150 mm, more preferably not more than 80 mm.

The key feature of the apparatus of the present invention is a DC pulsed voltage power source (22) connected to the cathode (18) and the anode (12b). The DC pulsed power (22) is applied to ignite an electrical arc inside the channel (16) with a pulse frequency of preferably not less than 1 Hz and more preferably not less than 10 Hz; and preferably not more than 10 kHz, more preferably not more than 1 kHz, and most preferably not more than 100 Hz. Assymetric pulse wave forms may also be used.

Sufficiently high voltage is initially applied to the cathode to ignite the arc. Preferably the initial voltage is not less than 700 V and more preferably not less than 1 kV, and preferably not more than 10 kV and more preferably not more than 5 kV. Once the plasma is ignited, it is then maintained at a voltage sufficiently high to avoid a short circuit but sufficiently low to have efficient energy transfer to maintain a stable arc, preferably in the range of 50 V to 150 V. The stable arc is then transformed into a plasma stream which is introduced into the chamber (50).

The Chamber

The last metal disc of the cascade arc source serves as the anode (12b) to electrically attract and accelerate electrons into the chamber (50), which is maintained at subatmospheric pressure to ensure maintenance of a high gas flow of the carrier through the conduit (16) and the chamber (50). Preferably, the pressure in the chamber, which is controlled by a means for evacuation (34), such as a vacuum pump, is not more than 1 Torr (1.3 mbar), more preferably not more than 0.2 Torr (0.26 mbar), and most preferably not more than 0.1 Torr (0.13 mbar), and preferably not less than 1 mTorr (1.3 μbar), more preferably not less than 10 mTorr (13 μbar), and most preferably not less than 30 mTorr (40 μbar).

One or more reactants is introduced into the plasma stream at the exit of the conduit (16b). The reactant, which has a higher vapor pressure than the pressure of the chamber, is introduced through a reactant channel (29) in communication with the chamber (50). Examples of suitable reactants include organosilanes, siloxanes, silazanes, aromatics, alkylene oxides, lower hydrocarbons, and acrylonitriles. An ancillary reactive gas such as oxygen, nitrogen, water, or hydrogen may be introduced into the chamber (50) along with the reactant. The ancillary reactive gas can be introduced either through the reactant inlet (29) along with the reactant or through a separate channel for the ancillary reactive agent (30). The reactant and ancillary reactive agent flow rates are preferably also controlled by the mass flow controller (31). Preferably the reactant is used in combination with the ancillary reactive gas. A preferred reactant is a disiloxane, more preferably tetramethyldisiloxane, and a preferred ancillary reactive gas is oxygen.

The reactant, either alone, or with the ancillary reactive gas are plasma polymerized to to deposit a coating on a substrate (32). The rate of deposition of the plasma polymerized material is proportional to the concentration of reactants introduced. Furthermore, the current (or power) is adjusted to maintain the desired rate of deposition of a particular chemical composition, while preferably maintaining a constant voltage. For example, to maintain a rate of deposition of the plasma polymerized material of from 0.1 μm/min to 1 μm/min the power is preferably adjusted to a level of not less than 100 W, and more preferably not less than 400 W, and preferably not higher than 10 kW, more preferably not higher than 5 kW.

The substrate (32) is not limited nor is its geometry. It can be metallic, polymeric (for example, plastic, rubber, or thermoset) composite, ceramic, cellulosic (for example, paper or wood), concrete. Examples of preferred substrates are polymeric substrates including polycarbonates; polyurethanes including thermoplastic and thermoset polyurethanes; polyesters such as polyethylene terephthalate and polybutylene terephthalate; polyolefins such as polyethylene and polypropylene; polyamides such as nylon; acrylates and methacrylates such as polymethylmethacrylate and polyethylmethacrylate; and polysulfones such as polyether sulfone.

Surprisingly, it has been discovered that the method of the present invention can produce an polyorganosilicon coated polyolefinic substrate in the absence of a tie layer. For example, it has been found that the adhesion strength of a organosilicon coated polyethylene substrate has a an adhesion strength as measured by a cross-hatch peel-off test (ASTM D3359-93) of 4 or 5, preferably 5.

The substrate (32) is situated directly below the cascade arc plasma source (40) and advantageously placed on a means for holding, moving, conveying, and/or rotating the substrate (36), at a distance sufficient to prepare the desired concentration over a particular area of the substrate. Examples of such means for holding, moving, conveying, and/or rotating the substrate (36) are well known in the art of plasma enhanced chemical vaporization coating technology. Generally, the closer the substrate (32) is to the plasma arc source (40) the more concentrated the coating over a smaller area. Likewise, the farther the substrate (30) is from the cascade arc source (40), the less concentrated the coating over a larger area. Preferably the distance between the substrate and the outlet for the carrier gas (16b) is not less than 5 cm, more preferably not less than 10 cm, and preferably not more than 50 cm, more preferably not more than 25 cm.

The device of the present invention is useful in making coated articles with enhanced barrier to gases such as oxygen, carbon dioxide, and nitrogen; and enhanced barrier to vapors such as water and organic compounds. Furthermore, the device is useful in preparing abrasion and scratch resistant coatings. Examples of end use products include coated high density polyethylene bottles for barrier packaging, coated polycarbonate for scratch and abrasion resistant window glazings for architectural and automotive applications.

### EXAMPLE 1

### Preparation of a Polycarbonate Sheet Coated with Cascade Arc Plasma Polymerized TMDSO and Oxygen

The conditions used to generate a polymerized TMDSO coating on a polycarbonate substrate using a tungsten filament cemented in ceramic and an MDX 11-30 power supply by Advanced Energy Instruments, Inc. are summarized in Table 1.

TABLE 1

| | |
|---|---|
| Flow rate (sccm) of TMDSO:O₂:Ar | 100:100:1000 |
| Power/Voltage/current (kW, V, amp) | 3/68/44 |
| Pulse frequency (Hz) | 20 |
| Substrate dimensions (cm³) | 0.32 × 30 × 30 |
| Distance of substrate to conduit exit (cm) | 18 |
| Deposition Time (min) | 1 |
| Chamber pressure (mBar) | 0.14 |

The plasma polymerized coating, as measured using the Taber abrasion test, had a delta haze of 3 after 1000 abrasion cycles using CSF-10 abrasion wheel at a 1000-g load.

### EXAMPLE 2

### Preparation of a Polypropylene Film Coated with Cascade Arc Plasma Polymerized TMDSO and Oxygen

The equipment used in Example 1 was used throughout these examples. The conditions used to generate a plasma polymerized TMDSO film on polypropylene film are summarized in Table 2.

TABLE 2

| | |
|---|---|
| Flow rate (sccm) of TMDSO:O₂:Ar | 5:150:1000 |
| Power/Voltage/current (kW, V, amp) | 3/67/46 |
| Pulse frequency (Hz) | 20 |
| Substrate dimensions (cm³) | 0.005 × 30 × 30 |
| Distance of substrate to conduit exit (cm) | 18 |
| Deposition Time (min) | 0.5 |
| Chamber pressure (mbar) | 0.13 |

The plasma polymerized coating, as measured using a Morcon barrier test, had an oxygen barrier of 7 cm³/m²/day at 38° C.

### EXAMPLE 3

### Preparation of a High Density Polyethylene Film Coated with Cascade Arc Plasma Polymerized TMDSO and Oxygen

The conditions used to generate a plasma polymerized TMDSO film on high density polyethylene film are summarized in Table 3.

TABLE 3

| | |
|---|---|
| Flow rate (sccm) of TMDSO:O₂:Ar | 5:150:1000 |
| Power/Voltage/current (kW, V, amp) | 3/68/42 |
| Pulse frequency (Hz) | 20 |
| Substrate dimensions (cm³) | 0.005 × 30 × 30 |
| Distance of substrate to conduit exit (cm) | 18 |
| Deposition Time (min) | 0.5 |
| Chamber pressure (mbar) | 0.13 |

The plasma polymerized coating, as measured using a Morcon barrier test, had an oxygen barrier of 6 cm³/m²/day/atm at 38° C.

What is claimed is:

1. A cascade arc plasma apparatus comprising:
1) a cascade arc source having a plurality of aligned concentric metallic discs separated by insulator rings, wherein the discs and rings contain a central aperture defining a conduit having an inlet and and an outlet for a carrier gas, which metallic discs float electrically between a cathode proximate to the inlet of the conduit and an anode proximate to the outlet of the conduit;
2) a DC pulsed voltage power source connected to the cathode and the anode;
3) a carrier gas source in communication with the inlet of the cascade arc source;
4) a vacuum deposition chamber in communication with the outlet of the cascade arc source, wherein the vacuum deposition chamber has a means for evacuation and at least one inlet for the introduction of monomer gas and optionally oxygen;
5) a source for a reactant in communication with the inlet of the vacuum deposition chamber; and
6) a substrate within the vacuum deposition chamber to receive plasma polymerized material.

2. A method for coating a substrate using cascade arc plasma comprising the steps of:
1) applying a DC pulse to generate a plasma in a cascade arc source having a plurality of aligned concentric metallic discs separated by insulator rings, wherein the discs and rings contain a central aperture defining a conduit having an inlet and an outlet for a carrier gas, wherein the metallic rings float electrically between a cathode proximate to the inlet of the conduit and an anode proximate to an outlet of the conduit, wherein the DC pulse is connected to the cathode and the anode;
2) concomitantly flowing a carrier gas through the conduit to form a cascade arc jet in a vacuum deposition chamber in communication with the outlet side of the cascade arc source;
3) contacting the cascade arc jet with a reactant and optionally an ancillary reactive gas to form a plasma polymerized material; and
4) depositing the plasma polymerized material onto a substrate within the vacuum deposition chamber.

3. A composition comprising a polyolefinic substrate coated with a polyorganic silicon layer in the absence of a tie layer for the substrate and the polyorganosilicon layer, wherein the coated substrate has a cross-hatch peel-off strength of 4 or 5.
